(19) United States
(12) Patent Application Publication
(10) Pub. No.: US 2010/0169782 A1
(43) Pub. Date: Jul. 1, 2010

(54) CONTENT AND/OR SERVICE GUIDING DEVICE AND GUIDING METHOD, AND INFORMATION RECORDING MEDIUM

(75) Inventors: Masayuki Chatani, Tokyo (JP); Hirotoshi Maegawa, Tokyo (JP); Takayuki Ishida, Tokyo (JP)

Correspondence Address: KATTEN MUCHIN ROSENMAN LLP, 575 MADISON AVENUE, NEW YORK, NY, 10022-2585, US

(73) Assignee: SONY COMPUTER ENTERTAINMENT INC., Tokyo (JP)

(21) Appl. No.: 12/278,830

(22) PCT Filed: Nov. 22, 2006
(86) PCT No.: PCT/JP2006/323331

§ 371 Date: Sep. 11, 2008

(30) Foreign Application Priority Data
Feb. 13, 2006 (JP) 2006-035877

(51) Int. Cl. G06F 3/048; G06F 3/01

(52) U.S. Cl. 715/730; 715/811; 715/810

(57) ABSTRACT

To facilitate finding of content or a service suitable for a user from a large amount of content sets and services. An image of a virtual three dimensional space (16) where a plurality of display elements (14) associated with respective content sets and/or services are placed is shown, and the user moves a designated position (10) in the virtual three dimensional space (16). Then, one or more display elements (14) are selected, based on the designated position (10), and a degree of relevance between user information and attribute information about each content, and associated content and/or service is presented.

### TECHNICAL FIELD

The present invention relates to a content and/or service presentation device and method and an information storage medium.

### BACKGROUND ART

As a content and/or service presenting user interface, there is known an interface for showing an icon representative of content and/or service on a screen or the name thereof in the form of a menu.

### DISCLOSURE OF THE INVENTION

### Problems to be Solved by the Invention

According to a conventional user interface, however, a user cannot know the contents of the content and/or service until a separate operation for using the content and/or service is actually carried out. This requires an enormous amount of time for the user to find content or a service suitable for them from among a large amount of content sets and services.

The present invention has been conceived in view of the above, and aims to provide a content and/or service presentation device and method and an information storage medium for enabling a user to readily find content and/or service suitable for them from among a large amount of content sets and services.

### Means for Solving the Problems

In order to achieve the above described object, according to one aspect of the present invention, there is provided content and/or service presentation device, comprising space image display means for displaying an image of a space in which a plurality of display elements associated with respective content sets and/or services are placed; presentation data storage means for storing, so as to be associated with the respective display element, at least one presentation data item for presenting the content or service associated with the display element; designated position moving means for moving by a user, the designated position in the space; and display element selection means for selecting one or more display elements from among the plurality of display elements, based on a distance between the designated position and the respective display element in the space, and a degree of relevance between user information concerning the user and attribute information about the content or service associated with the respective display element.

In the present invention, the content and/or service presentation device further comprises reading means for reading any presentation data stored in the presentation data storage means so as to be associated with the respective display element selected by the display element selection means; and presentation means for presenting the content or service associated with the respective display element selected by the display element selection means, based on the presentation data read by the reading means

According to another aspect of the present invention, there is provided a content and/or service presentation method, comprising a space image display step of displaying an image of a space in which a plurality of display elements associated with respective content sets and/or services are placed; a designated position moving step of moving, by a user, the designated position in the space; and a display element selection step of selecting one or more display elements from among the plurality of display elements, based on a distance between the designated position and the respective display element in the space, and a degree of relevance between user information concerning the user and attribute information about the content or service associated with the respective display element; a reading step of reading any presentation data stored in a presentation data storage means so as to be associated with the respective display element selected at the display element selection step; and a presentation step of presenting the content or service associated with the respective display element selected at the display element selection step, based on the presentation data read at the reading step.

According to still another aspect of the present invention, there is provided an information storage medium storing a program for causing a computer to function as space image display means for displaying an image of a space in which a plurality of display elements associated with respective content sets and/or services are placed; presentation data storage means for storing, so as to be associated with the respective display element, at least one presentation data item for presenting the content or service associated with the display element; designated position moving means for moving by a user, the designated position in the space; display element selection means for selecting one or more display elements from among the plurality of display elements, based on a distance between the designated position and the respective display element in the space, and a degree of relevance between user information concerning the user and attribute information about the content or service associated with the respective display element; reading means for reading any presentation data stored in the presentation data storage means so as to be associated with the respective display element selected by the display element selection means; and presentation means for presenting the content or service associated with the respective display element selected by the display element selection means, based on the presentation data read by the reading means. Here, the computer may include, e.g., a content player, a personal computer, a server computer, a consumer game machine, a commercial game device, a portable game device, a portable phone, and so forth. The program may be stored in a computer readable various information storage medium, such as CD-ROM, DVD-ROM, and so forth.

According to the present invention, an image of a space where a plurality of display elements associated with respective content sets and/or services are placed is shown, and the user can move the designated position in the space. Then, one or more display elements are selected, based on the distance between the position designated by the user and the position of the respective display element in the space, and the degree of relevance between the user information and the attribute information about content or service associated with the respective display element. For example, a display element for which degree of relevance between the user information and the attribute information about content or service associated with the respective display element is equal to or larger than a predetermined value may be selected from among those placed within a predetermined distance from the position designated by the user. Then, for the selected display element, associated content and/or service is presented.

Therefore, presentation of one or more content sets and/or services begins when the designated position is simply moved by the user in the space even though the user does not deliberately instruct execution of the content and/or service. In this case, content and/or service to be presented is selected according to the degree of relevance between the user information and the concerned attribute information. Therefore, according to the present invention, the user can readily find content and service suitable for the user themselves.

In one embodiment of the present invention, the content and/or service presentation device may further comprises usage history storage means for storing, as the user information, usage history concerning the content and/or service, wherein the display element selection means may calculate a degree of relevance between attribute information about the content and/or service contained in the usage history stored in the usage history storage means and the attribute information about the content or service associated with the respective display element, and selects one or more display elements from the plurality of display elements, based on the relevance degree and the distance. With the above, a display element associated with content or service having attribute information similar to that of content or service contained in the usage history is selectively presented.

In this case, the usage history storage means may store usage history concerning content and/or a service concerning the user as the user information. Also, the usage history storage means may store usage history concerning content and/or service concerning a person other than the user as the user information.

Also, the content and/or service presentation device may further comprises path history storage means for storing path history concerning the designated position, wherein the display element selection means may select one or more display elements from among the plurality of display elements, based further on the path history stored in the path history storage means. With the above, presentation can be made with respect to a display element placed near the path along which the position designated by the user has been moved.

Also, the attribute information about the content or service associated with the respective display element may include information specifying a kind of the content or service associated with the display element. With the above, selective presentation according to a kind of content or service can be attained.

Also, at least a part of the attribute information about the content or service associated with the respective display element may be set from outside via a communication network. With the above, content or service to be presented can be controlled from the outside.

Also, the presentation means may output image and/or sound corresponding to the content or service associated with the respective display element selected by the display element selection means, based on the presentation data read by the reading means. The image may be either a movie or a still image. Preferably, the image may be shown in the position of an associated display element.

### BRIEF DESCRIPTION OF THE DRAWINGS

FIG. 1 is a diagram schematically showing a space where a display element associated with content/service is placed;

FIG. 2 is a diagram showing one example of a display screen image;

FIG. 3 is a functional block diagram showing a content and/or service presentation device according to one embodiment of the present invention;

FIG. 4 is a diagram showing a structure of a control unit;

FIG. 5 is a diagram showing contents stored in a space information storage unit; and

FIG. 6 is a flowchart of an operation of the control unit of the content and/or service presentation device according to one embodiment of the present invention.

### BEST MODE FOR CARRYING OUT THE INVENTION

In the following, one embodiment of the present invention will be described in detail with reference to the accompanying drawings.

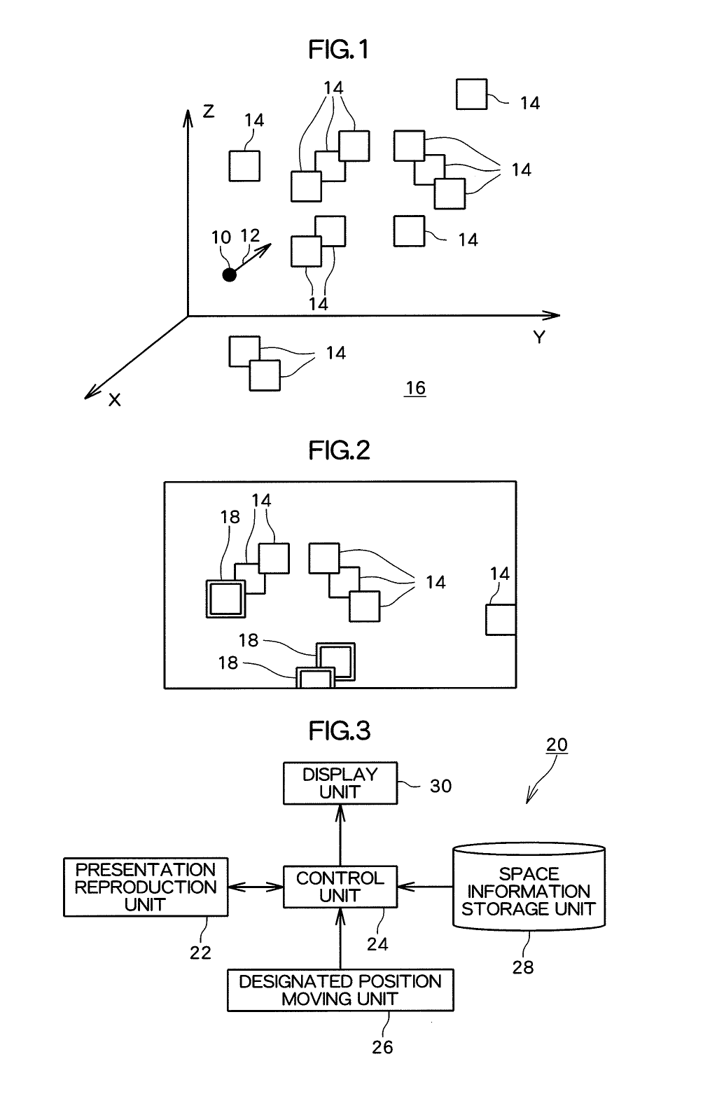

FIG. 1 schematically shows a virtual three dimensional space created in a memory of a presentation device according to one embodiment of the present invention. As shown, a plurality of display elements 14 are placed in the virtual three dimensional space 16, each associated with content or a service, and including, e.g., a static image in relation to the content or service. A position 10 designated by a user (designated position 10) and a direction 12 designated by the user (designated direction 12) are set in the virtual three dimensional space 16. Situation in the virtual three dimensional space 16 with the designated position 10 as a viewpoint and the designated direction 12 as a sight line direction is put into an image and shown on a monitor. That is, an image showing a picture obtained by viewing the virtual three dimensional space 16 from the designated position 10 in the designated direction 12 is produced and shown on the monitor.

FIG. 2 shows one example of an image shown on the monitor. As shown, the image includes some of the display elements 14 placed in the virtual three dimensional space 16. A display element 14 which is a focusing target defined ahead (on the designated direction 12 side) of the designated position 10 in the virtual three dimensional space 16 is not shown, but a presentation image 18 is shown instead. The presentation image 18 is a motion image showing contents of the content or service associated with the display element 14 located in the same position as where the presentation image 18 is located. The motion image may be a motion image showing a part or the entirety of the contents of the content or service or a different motion image. The presentation device according to this embodiment has an input device for use by a user to desirably move the designated position 10 in the virtual three dimensional space 16 and change the designated direction 12. That is, it is possible to move, by pressing a specific button, the designated position 10 in a direction corresponding to the button in the virtual three dimensional space 16, and to turn, by pressing another specific button, the designated direction 12 in a direction corresponding to the button in the virtual three dimensional space 16. That is, for a display element 14 to be selected according to the designated position, a relevant presentation image 18 is shown on the monitor. In the above, announcement sound corresponding to the display element 14 may be additionally output. For example, sounds corresponding to the content sets or services associated with the presentation images 18 may be mixed and output. A mixing ratio may be preferably determined based on the distance between each presentation image 18 and the designated position 10 in the virtual three dimensional space 16. Specifically, smaller sound may be output with respect to a presentation image 18 located farther from the designated position, while larger sound may be output with respect to a presentation image 18 located closer thereto, whereby mixed sound is preferably output as if sound output from each presentation image 18 were heard in the designated position 10. Moreover, sound corresponding to each presentation image 18 may be corrected such that tempos and beat timings thereof are matched. This makes the mixing output more comfortably accepted by the user. With the above, the user, by simply changing the designated position 10 and designated direction 12, can convert the display element 14 located ahead of the designated position 10 into a presentation image 18, and thereby know the contents of the content and service associated with the display element 14.

Further, in this embodiment, user information and attribute information of content or service associated with a respective display element are referred to in selection of a focusing target display element 14. Attribute information includes information about age, sex, residential location, occupation, or the like, of a user to which the content or service is directed, and information specifying the kind of content or service. User information includes information about age, sex, residential location, occupation, and so forth, and information, or usage history, about content or service ever used by the user (including review of content and use of service). Information specifying the kind of content or service ever used by the user may be additionally included. Then, a degree of relevance (or a matching degree) between user information and attribute information of a respective display element is calculated, and a display element having the relevance degree equal to or larger than a predetermined value is selected as a focusing target. That is, a display element, for which relevance degree is equal to or larger than a predetermined value among those located in the designated direction 12 within a predetermined distance from the position 10 designated by the user, is selected as a focusing target. In this embodiment, as a focusing target is selected according to the user information and the content or service attribute information, as described above, content or service in conformity with the user is presented, whereby effective presentation is realized.

It should be noted that in focusing target selection, not only content/service usage history concerning the user themselves, but also that for the user's acquaintances may be used as user information concerning the user themselves. This enables presentation of content/or service according to the acquaintance's taste. That is, content or service which the user themselves do not use much may be presented.

Specifically, history stating that content or service is used is stored so as to be associated with the concerned display element 14, and that information is used as a relevance degree (information indicating an extent of relevance between the user and the content or service). This makes it possible to select or not select a display element in a focus area as a focusing target according to the history information.

The usage history is not limited to that concerning the display element 14 associated with the concerned content or service but also that concerning any display element 14 located near (within a predetermined distance from) the display element 14 in the virtual three dimensional space 16. Specifically, using usage history concerning a display element 14, either intact or modified, located near the concerned display element 14 as a degree of relevance makes it possible to select or not select as a focusing target a display element 14 within a focus area.

It should be noted that not only the usage history concerning the current user of the presentation device but also that assigned by other person, such as an acquaintance or the like, may be usable. Accordingly, the user can access content close to the acquaintance's taste, in other words, the user can readily find and use (enjoy) content in conformity with the acquaintance's taste. That is, the user can more readily understand content distribution tendency in the space 16, based on their knowing character of the acquaintance, and accordingly can more readily access their desired content.

Further, path history concerning the designated position 10, stored beforehand, may be referred to in focusing target selection. With the above, a display element 14 located within a predetermined distance from any past designated position 10 included in the path history can be selected as a focusing target. As a result, in the case where content sets or services similar in the contents are placed close to one another in the virtual three dimensional space 16, it is possible to make presentation of content or service similar to one having been presented or used in response to the designated position 10 moved by the user.

Still further, it is preferable that history telling the types of presentations having been made thus far with respect to past focusing target presentation elements 14 is stored, so that a newly selected focusing target display element 14 is presented in a similar manner. For example, in the case where past focusing target display elements 14 have been presented by outputting presentation sound, presentation sound may be also output with respect to the next focusing target display element 14 even though presentation sound and image are both available for the display element 14.

Yet further, a display element 14 adapted to presentation of a type similar to that for past focusing target display elements 14 may be selected as a new focusing target from among those located within the focus area. That is, with respect to a user having seen display elements 14 presented by outputting announcement sound, display elements 14 adapted to announcement sound output may be mainly selected as focusing targets. This arrangement can readily enable the user to recognize only content or service of a similar kind. In another example, in the case where the designated position 10 has been moved along a path in a music content highly populated area in an area where music content and motion image content coexist, more music content sets may be presented to the user with the designated point 10 in the current position. This makes it possible, while maintaining the context of enjoying music content, to present to a user having reached a certain area, a content presentation space as an environment in which the user can naturally and readily enjoy music content.

Note that the path history of the designated position 10 may be the result of operation not only by the user themselves, but also by another user. That is, such path history may be received from another device via a communication network.

In this case, the user can readily understand content distribution tendency in the space, based on the user's knowing character or recent inclination tendency of their acquaintance, and thus can readily access their own desired content.

Further, content or service attribute information may be set via a communication network. In this case, either a content or service provider or an irrelevant third party may set all or part of the attribute information. With the above, content or service to be presented is controlled by either a content or service provider or an irrelevant third party.

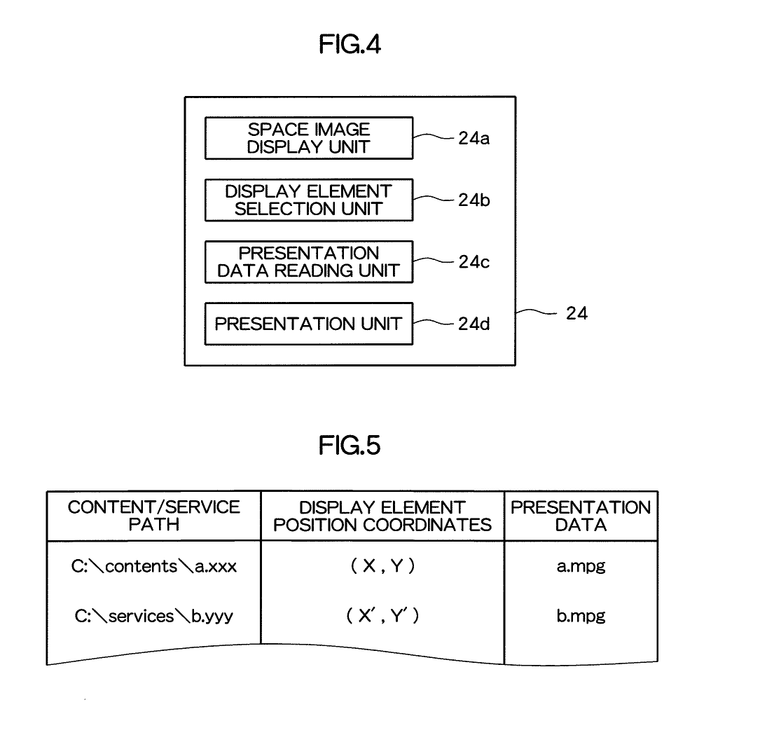

FIG. 3 is a functional block diagram showing a presentation device according to this embodiment. As shown, the presentation device 20 comprises a presentation reproduction unit 22, a control unit 24, a designated position moving unit 26, a space information storage unit 28, and a display unit 30. As shown in FIG. 4, the control unit 24 comprises a space image display unit 24a, a display element selection unit 24b, a presentation data reading unit 24c, and a presentation unit 24d. These elements are realized by a computer, such as a contents player, a personal computer, a consumer game machine, and so forth, by executing a program. The program may be stored in a computer readable information storage medium, such as, e.g., CD-ROM, DVD-ROM, or the like, and installed from the medium into the computer.

The designated position moving unit 26 comprises a joystick, a PAD, a game controller, and so forth, for use by a user to desirably move the designated position 10 or change the designated direction 12 in the virtual three dimensional space 16. The control unit 24 produces an image of the virtual three dimensional original image 16, or a space image, according to the current designated position 10 and designated direction 12, and causes display on the display unit 30. In production of the space image, the control unit 24 refers to the contents stored in the space information storage unit 28. Note that to show the presentation image 18 instead of the display element 14, as described above, the presentation reproduction unit 22 produces the presentation image 18.

The space information storage unit 28 stores information about the virtual three dimensional space 16. Specifically, as shown in FIG. 5, the space information storage unit 28 stores, for each content/service, a path to reproduce the content or to use the service, position coordinates (display element position coordinates) in which to display the display element 14 associated with the content/service in the virtual three dimensional space 16, and presentation data. Presentation data is data necessary to present to a user the contents of content/service, including, e.g., motion image data, music data, video image (a combination between motion image and sound) data, all concerning the contents of the content/service, or a program for outputting a motion image, sound, or a video image.

The display element selection unit 24b of the control unit 24 reads from the space information storage unit 28, the display element position coordinates associated with respective content sets/services, and selects from among the read position coordinates, ones within a predetermined distance from the current designated position 10 and within a predetermined angular range with the designated direction 12 extending in the middle thereof. Further, a focusing target is selected from among the display elements 14 associated with the selected position coordinates, based on the user information and the attribute information about content sets or services associated with respective the display elements 14. Specifically, a degree of relevance between the user information and the content or service attribute information is calculated, and a display element 14 of which relevance degree is equal to or larger than a predetermined value is selected as a focusing target.

For example, the display element selection unit 24b may store, as user information, content and/or service usage history. Usage history may concern the user themselves, as described above, or another person. In this case, a degree of relevance between the content and/or service attribute information contained in the usage history stored and the attribute information about content or service associated with a respective display element is calculated, and a focusing target is selected based on the relevance degree.

Further, the display element selection unit 24b may store path history of the designated position 10. In this case, the display element selection unit 24b can select a focusing target, based further on the path history stored. Still further, the display element selection unit 24b may obtain, as attribute information about content or service associated with a respective display element, attribute information containing information specifying the kind of content or service associated with the display element, and selects a focusing target while referring to the kind of content or service.

The presentation information data reading unit 24c reads presentation data stored in the space information storage unit 28 in association with the display element 14 selected as a presentation target by the display element selection unit 24b, and supplies the read presentation data to the presentation reproduction unit 22, while instructing to begin production of presentation image 18 and/or announcement sound.

The presentation reproduction unit 22 produces a presentation image 18 and announcement sound, based on the presentation data supplied from the control unit 24, and forwards to the control unit 24. The presentation unit 24d, having obtained the presentation image 18 and announcement sound, places the presentation image 18 in the position where the display element 14 associated with the presentation image 18 is located in the virtual three dimensional space 16, and outputs the announcement sound via the speaker (not shown).

The space image display unit 24a produces an image of the virtual three dimensional space 16 where the presentation image 18 is thus placed, and causes this image to be displayed on the display unit 30 comprising a monitor such as a CRT, an LCD, or the like.

If the display element position coordinates of the content/service with respect to which the presentation image 18 and announcement sound are currently output come to be no longer included in the focus area in the virtual three dimensional space 16 as the designated position 10 is moved and/or the designated direction 12 is changed, the presentation unit 24d stops displaying the presentation image 18 and/or outputting the announcement sound.

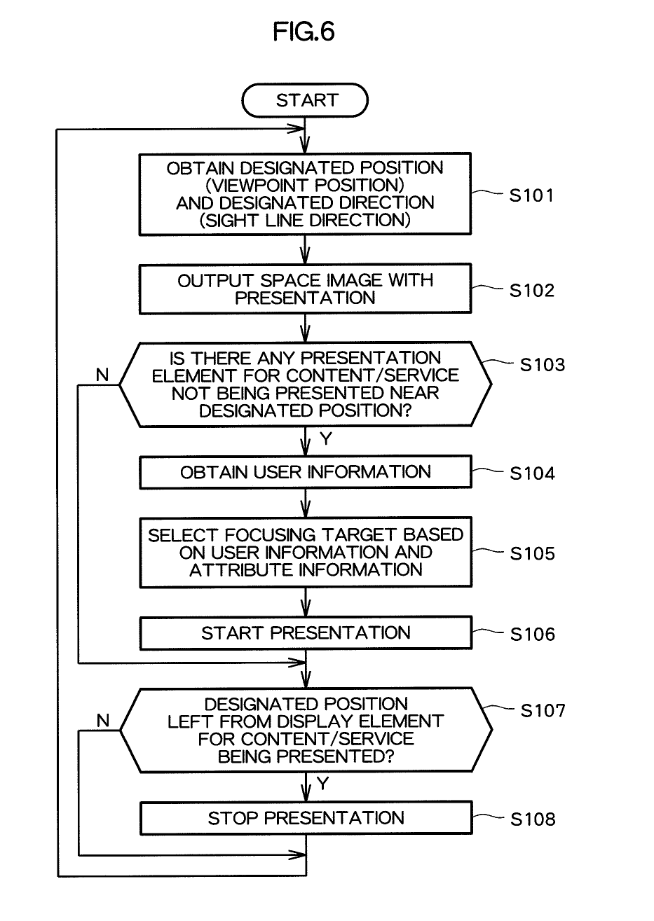

FIG. 6 is a flowchart of an operation of the control unit 24. As shown, the control unit 24 initially obtains the current designated position 10 and designated direction 12 from the designated position moving unit 26 (S101), then produces an image (a space image) showing a picture obtained by viewing from the designated position 10 in the designated direction 12 the virtual three dimensional space 16 where the display element 14 or presentation image 18 is placed in the display element position coordinates, stored in the space information storage unit 28, and outputs to the display unit 30 (S102). In the above, if announcement sound is available as produced by the presentation reproduction unit 22, the announcement sound is output via the speaker.

Thereafter, it is determined whether or not there are any display element position coordinates newly included in a focus area (a conical area having a vertex in the designated position 10 and an axis extending in the designated direction 12, and so forth) defined based on the current designated position 10 and designated direction 12 (S103). If there are any such display element position coordinates, various user information items are obtained (S104), and a focusing target display element 14 is selected from among those placed in the position coordinates, based on the degree of relevance between the user information and the attribute information about content or service associated with the position coordinates (S105).

Thereafter, presentation data associated with the thus selected focusing target is read from the space information storage unit 28, and supplied to the presentation reproduction unit 22, while instructing to begin production of presentation image 18 and/or announcement sound (S106). Meanwhile, if there are no such display element position coordinates newly included in the focus area defined based on the current designated position 10 and designated direction 12 (S103), the processes at S104 to S106 are skipped.

Thereafter, when the display element position coordinates of the content/service, with respect to which the presentation image 18 or announcement sound is currently produced by the presentation reproduction unit 22, are outside the focus area (S107), the presentation unit 24d of the control unit 24 instructs the presentation reproduction unit 22 to stop current production of the presentation image 18 and announcement sound (S108), and the above described processes (S101 to S108) are repeated for every predetermined period of time. Meanwhile, if the display element position coordinates of the content/service with respect to which the presentation image 18 or announcement sound is currently produced by the presentation reproduction unit 22 remains within the focus area (S107), the process at S108 is skipped.

According to the above described embodiment, upon desirable change by the user of the designated position 10 and designated direction 12, presentation of the content and service begins. That is, the contents of content or service is automatically presented, even though the user does not deliberately carry out any specific operation to produce the content or begin the service. This arrangement can effectively arouse a user's interest in the content and service. Also, as the content and/or service to be presented is selected according to the degree of relevance between the user information and the content and/or service attribute information, content and service in which a user may be interested can be selectively presented. This enables more effective presentation of content and service.

It should be noted that although it is described in the above embodiment that the degree of relevance between the user information and the attribute information about content or service associated with a respective display element 14 among those contained in the focus area defined according to the current designated position 10 and designated direction 1 is calculated, so that a display element having the relevance degree equal to or larger than a predetermined value is selected as a focusing target, the present invention is not limited to the above. That is, a focusing target may be determined based on comprehensive evaluation of a positional relationship between a respective display element 14 and the current designated position 10 and designated direction 12, and the degree of relevance between the user information and the attribute information about content or service associated with the display element 14. This arrangement enables control such that a display element 14 having a larger degree of relevance is selected as a focusing target even though located at a longer distance from the designated position 10 (that is, shown small on the display unit 30) and a display element 14 having a smaller degree of relevance is not selected as a focusing target even though located at a shorter distance from the designated position 10 (that is, shown large on the display unit 30). Specifically, two elements, namely, a degree of display concerning how the display element 14 determined based on the current designated position 10 and designated direction 12 is shown on the display unit 30 and the above described degree of relevance, are evaluated using an evaluation function, such as addition, multiplication, and so forth, to determine whether or not the display element 14 is selected as a focusing target.

1.-11. (canceled)

12. A content and/or service presentation device, comprising:
space image display means for displaying an image of a space in which a plurality of display elements associated with respective content sets and/or services are placed;
presentation data storage means for storing, so as to be associated with the respective display element, at least one presentation data item for presenting the content or service associated with the display element;
designated position moving means for moving by a user, the designated position in the space; and
display element selection means for selecting one or more display elements from among the plurality of display elements, based on a distance between the designated position and the respective display element in the space, and a degree of relevance between user information concerning the user and attribute information about the content or service associated with the respective display element.

13. The content and/or service presentation device according to claim 12, further comprising:
reading means for reading any presentation data stored in the presentation data storage means so as to be associated with the respective display element selected by the display element selection means; and
presentation means for presenting the content or service associated with the respective display element selected by the display element selection means, based on the presentation data read by the reading means.

14. The content and/or service presentation device according to claim 12, further comprising:
usage history storage means for storing, as the user information, usage history concerning the content and/or service,
wherein
the display element selection means calculates a degree of relevance between attribute information about the content and/or service contained in the usage history stored in the usage history storage means and the attribute information about the content or service associated with the respective display element, and selects one or more display elements from the plurality of display elements, based on the degree of relevance and the distance.

15. The content and/or service presentation device according to claim 14, wherein the usage history storage means stores usage history concerning content and/or service concerning the user, as the user information.

16. The content and/or service presentation device according to claim 14, wherein the usage history storage means stores usage history concerning content and/or service concerning a person other than the user as the user information.

17. The content and/or service presentation device according to claim 12, further comprising:
path history storage means for storing path history concerning the designated position,
wherein
the display element selection means selects one or more display elements from among the plurality of display elements, based further on the path history stored in the path history storage means.

18. The content and/or service presentation device according to claim 12, wherein the attribute information about the content or service associated with the respective display element includes information specifying a kind of the content or service associated with the display element.

19. The content and/or service presentation device according to claim 12, wherein at least a part of the attribute information about the content or service associated with the respective display element is set from outside via a communication network.

20. The content and/or service presentation device according to claim 12, wherein the presentation means outputs image and/or sound corresponding to the content or service associated with the respective display element selected by the display element selection means, based on the presentation data read by the reading means.

21. A content and/or service presentation method, comprising:
a space image display step of displaying an image of a space in which a plurality of display elements associated with respective content sets and/or services are placed;
a designated position moving step of moving, by a user, the designated position in the space; and
a display element selection step of selecting one or more display elements from among the plurality of display elements, based on a distance between the designated position and the respective display element in the space, and a degree of relevance between user information concerning the user and attribute information about the content or service associated with the respective display element;
a reading step of reading any presentation data stored in a presentation data storage means so as to be associated with the respective display element selected at the display element selection step; and
a presentation step of presenting the content or service associated with the respective display element selected at the display element selection step, based on the presentation data read at the reading step.

22. An information storage medium storing a program for causing a computer to function as,
space image display means for displaying an image of a space in which a plurality of display elements associated with respective content sets and/or services are placed;
presentation data storage means for storing, so as to be associated with the respective display element, at least one presentation data item for presenting the content or service associated with the display element;
designated position moving means for moving, by a user, the designated position in the space;
display element selection means for selecting one or more display elements from among the plurality of display elements, based on a distance between the designated position and the respective display element in the space, and a degree of relevance between user information concerning the user and attribute information about the content or service associated with the respective display element;
reading means for reading any presentation data stored in the presentation data storage means so as to be associated with the respective display element selected by the display element selection means; and
presentation means for presenting the content or service associated with the respective display element selected by the display element selection means, based on the presentation data read by the reading means.

23. A content and/or service presentation device, comprising:
space image display unit for displaying an image of a space in which a plurality of display elements associated with respective content sets and/or services are placed;
presentation data storage unit for storing, so as to be associated with the respective display element, at least one presentation data item for presenting the content or service associated with the display element;
designated position moving unit for moving by a user, the designated position in the space; and
display element selection unit for selecting one or more display elements from among the plurality of display elements, based on a distance between the designated position and the respective display element in the space, and a degree of relevance between user information concerning the user and attribute information about the content or service associated with the respective display element.

24. The content and/or service presentation device according to claim 23, further comprising:
reading unit for reading any presentation data stored in the presentation data storage means so as to be associated with the respective display element selected by the display element selection unit; and
presentation unit for presenting the content or service associated with the respective display element selected by the display element selection unit, based on the presentation data read by the reading unit.

25. The content and/or service presentation device according to claim 23, further comprising:
usage history storage unit for storing, as the user information, usage history concerning the content and/or service,
wherein
the display element selection unit calculates a degree of relevance between attribute information about the content and/or service contained in the usage history stored in the usage history storage unit and the attribute information about the content or service associated with the respective display element, and selects one or more display elements from the plurality of display elements, based on the degree of relevance and the distance.

26. The content and/or service presentation device according to claim 25, wherein the usage history storage unit stores usage history concerning content and/or service concerning the user, as the user information.

27. The content and/or service presentation device according to claim 25, wherein the usage history storage unit stores usage history concerning content and/or service concerning a person other than the user as the user information.

28. The content and/or service presentation device according to claim 23, further comprising:
path history storage unit for storing path history concerning the designated position,
wherein
the display element selection unit selects one or more display elements from among the plurality of display elements, based further on the path history stored in the path history storage unit.

29. The content and/or service presentation device according to claim 23, wherein the attribute information about the content or service associated with the respective display element includes information specifying a kind of the content or service associated with the display element.

30. The content and/or service presentation device according to claim 23, wherein at least a part of the attribute information about the content or service associated with the respective display element is set from outside via a communication network.

31. The content and/or service presentation device according to claim 23, wherein the presentation means outputs image and/or sound corresponding to the content or service associated with the respective display element selected by the display element selection unit, based on the presentation data read by the reading unit.

32. A content and/or service presentation method, comprising:
displaying an image of a space in which a plurality of display elements associated with respective content sets and/or services are placed;
moving, by a user, the designated position in the space; and
selecting one or more display elements from among the plurality of display elements, based on a distance between the designated position and the respective display element in the space, and a degree of relevance between user information concerning the user and attribute information about the content or service associated with the respective display element;
reading any presentation data stored in a presentation data storage means so as to be associated with the respective selected display element; and
presenting the content or service associated with the respective selected display element, based on the read presentation data at the reading step.

33. An information storage medium storing a program for causing a computer to function as,
space image display unit for displaying an image of a space in which a plurality of display elements associated with respective content sets and/or services are placed;
presentation data storage unit for storing, so as to be associated with the respective display element, at least one presentation data item for presenting the content or service associated with the display element;
designated position moving unit for moving, by a user, the designated position in the space;
display element selection unit for selecting one or more display elements from among the plurality of display elements, based on a distance between the designated position and the respective display element in the space, and a degree of relevance between user information concerning the user and attribute information about the content or service associated with the respective display element;
reading unit for reading any presentation data stored in the presentation data storage unit so as to be associated with the respective display element selected by the display element selection unit; and
presentation unit for presenting the content or service associated with the respective display element selected by the display element selection unit, based on the presentation data read by the reading unit.
